(19) United States
(12) Patent Application Publication
(10) Pub. No.: US 2020/0277444 A1
(43) Pub. Date: Sep. 3, 2020

(54) Polysiloxane Urethane Compounds and Optically Transparent Adhesive Compositions

(71) Applicants: Henkel IP & Holding GmbH, Duesseldorf (DE); Henkel AG & Co. KGaA, Duesseldorf (DE)

(72) Inventors: Qinyan Zhu, Cheshire, CT (US); Yoshihiko Misumi, Kanagawa (JP); David P. Dworak, Middletown, CT (US); Shuhua Jin, Cheshire, CT (US)

(21) Appl. No.: 15/929,728

(22) Filed: May 19, 2020

Related U.S. Application Data
(63) Continuation of application No. PCT/US2018/062596, filed on Nov. 27, 2018.
(60) Provisional application No. 62/590,794, filed on Nov. 27, 2017.

(51) Int. Cl. C08G 77/38; C09J 183/04

(52) U.S. Cl. CPC C08G 77/38; C09J 183/04; C09J 2433/00; C08G 2170/00; C09J 2483/00

(57) ABSTRACT

Disclosed is a terminally functionalized polysiloxane urethane polymer comprising: polysiloxane segments comprising from 50 to 98% by weight based on the total polymer weight; urethane segments comprising from 2 to 50% by weight based on the total polymer weight; and terminal functional groups selected from (meth)acrylate functional groups, isocyanate functional groups and mixtures thereof. The terminally functionalized polysiloxane urethane polymer finds use in liquid optically clear adhesive formulations wherein it can provide dual photo and moisture cure properties. In some embodiments cured reaction products of the liquid optically clear adhesive composition prepared with the terminally functionalized polysiloxane urethane polymer exhibit low haze of 2% or less and low yellowness b* values of 2 or less as prepared and after aging testing. In some embodiments cured reaction products of the liquid optically clear adhesive composition prepared with the terminally functionalized polysiloxane urethane polymer exhibit minimal shrinkage.

### TECHNICAL FIELD

This disclosure relates generally to liquid optically clear adhesives and more particularly to polysiloxane urethane compounds for use in liquid optically clear adhesive compositions.

### BACKGROUND OF THE INVENTION

This section provides background information which is not necessarily prior art to the inventive concepts associated with the present disclosure.

Currently, in many electronic industry fields, such as the manufacture of LCD touch panels and display panels, adhesives are used to bond various substrates and assemblies together. Conventional adhesives used in such applications are cured by exposure to actinic radiation such as ultraviolet (UV) radiation or visible light. UV radiation is in the range of 100 to 400 nanometers (nm). Visible light is in the range of 400 to 780 nanometers (nm). However, complicated and special designs and opaque parts, such as those caused by ceramics and metals result in areas transparent to UV radiation and shadow areas that UV radiation and visible light cannot penetrate in display panels and touch panel devices. This is especially true for displays used in automotive display panels and other panels. These large shadow areas make it difficult to utilize adhesives that are cured by exposure to actinic radiation. These LOCA compositions are also used in other displays such as mobile phone screens, tablet screens and television screens and in formation of HHDD. Any adhesive utilized must also be as optically clear as possible, these adhesives are typically known as Liquid Optically Clear Adhesives (LOCA). Because of the difficulty in using a radiation only curable LOCA, in some cases manufacturing processes have moved to use of LOCA that are curable by exposure to both actinic radiation and thermal energy.

In addition to the radiation curable adhesives and thermally curable adhesives, conventional moisture curable LOCA adhesives can bond various kinds of substrates used in these systems. These LOCA compositions can be cured by exposure to moisture in the air or on the substrate to be bonded.

Silicone based actinic radiation and moisture curable LOCA compositions that are currently available tend to have very low modulus and low glass transition temperatures. While they have reasonable temperature range stability they have low compatibility with current visible light photoinitiators and moisture cure catalysts making it difficult to control adequate curing. These adhesives also tend to have high moisture permeability which results in development of excessive haze under high temperature and high humidity conditions. Organic acrylate based LOCA compositions have good compatibility with photoinitiators and can have low moisture permeability; however they always exhibit high shrinkage and a wide range of glass transition temperatures which causes defects or delamination from plastic substrates during thermal cycling from −40° C. to 100° C. When one combines silicone based and organic acrylate based LOCAs together the resulting adhesive composition has an objectionably high level of haze because of incompatibility of the two polymers.

Any adhesive used to assemble these devices must meet several requirements including: an ability to cure in the large shadow areas where actinic radiation cannot penetrate; the ability to cure acceptably even when the actinic radiation is minimized by having to first pass through overlying plastic substrates; the ability to bond to a variety of materials including those formed from polymethylmethacrylate (PMMA), polycarbonate (PC) and/or polyethylene terephthalate (PET) a temperature ranges of from −40 to 100° C.; optical clarity in the cured state and very low hazing and yellowness values under conditions of high temperature, high humidity and strong UV radiation. There remains a need for a LOCA adhesive composition that can fulfill these criteria and that is curable by both exposure to actinic radiation and moisture.

### SUMMARY OF THE DISCLOSURE

This section provides a general summary of the disclosure and is not a comprehensive disclosure of its full scope or all features, aspects or objectives.

In an embodiment the present disclosure provides a polysiloxane urethane polymer including: polysiloxane segments comprising from 50 to 98% by weight based on the total polymer weight; urethane segments comprising from 2 to 50% by weight based on the total polymer weight; and terminal functional groups selected from at least one of (meth)acrylate functional groups, isocyanate functional groups, or mixtures thereof

In an embodiment the terminal functional groups comprise (meth)acrylate functional groups.

In an embodiment the terminal functional groups comprise isocyanate functional groups.

In an embodiment the terminal functional groups comprise a mixture of (meth)acrylate functional groups and isocyanate functional groups.

In an embodiment the functionalized polymer has a number average molecular weight of from 1,000 to 100,000 and preferably from 3,000 to 70,000.

In an embodiment the disclosure provides a liquid optically clear adhesive composition comprising: a functionalized polysiloxane urethane polymer comprising polysiloxane segments comprising from 50 to 98% by weight based on the total polymer weight, urethane segments comprising from 2 to 50% by weight based on the total polymer weight and terminal functional groups comprising at least one of (meth)acrylate functional groups, isocyanate functional groups, or mixtures thereof, the end-capped polysiloxane urethane polymer present in an amount of from 30 to 99.8% by weight based on the total composition weight; optionally, at least one (meth)acrylate monomer present in an amount of from 0 to 50% by weight based on the total composition weight; a photoinitiator present in an amount of from 0.01 to 3% by weight based on the total composition weight; optionally, a moisture curing catalyst present in an amount of from 0 to 1% by weight based on the total composition weight; and optionally one or more additives selected from the group consisting of photostabilizers, thermal stabilizers, leveling agents, thickeners and plasticizers, said additive present in an amount of from 0 to 5% by weight based on the total composition weight.

In an embodiment the liquid optically clear adhesive composition comprises a functionalized polysiloxane urethane polymer having terminal (meth)acrylate functional groups.

In an embodiment the liquid optically clear adhesive composition comprises a functionalized polysiloxane urethane polymer having terminal isocyanate functional groups.

In an embodiment the liquid optically clear adhesive composition comprises a functionalized polysiloxane urethane polymer having a mixture of terminal (meth)acrylate functional groups and terminal isocyanate functional groups.

In an embodiment the liquid optically clear adhesive composition comprises a functionalized polymer having a number average molecular weight of from 1,000 to 100,000 and preferably from 3,000 to 70,000.

In an embodiment the liquid optically clear adhesive composition includes at least one of the (meth)acrylate monomers present in an amount of from 0 to 50% by weight, more preferably from 1 to 10% by weight based on the total composition weight.

In an embodiment the liquid optically clear adhesive composition has a moisture cure catalyst present in an amount of from 0.01 to 1% by weight based on the total weight of the composition.

In an embodiment the liquid optically clear adhesive composition as prepared has a haze value of from 0 to 2%.

In an embodiment the liquid optically clear adhesive composition has a haze value of from 0 to 2% after being stored for 500 hours at 85° C. and 85% relative humidity.

In an embodiment the liquid optically clear adhesive composition as prepared has a yellowness b* value of from 0 to 2.

In an embodiment the liquid optically clear adhesive has a yellowness b* value of from 0 to 2 after being stored for 500 hours at 85° C. and 85% relative humidity.

These and other features and advantages of this disclosure will become more apparent to those skilled in the art from the detailed description of a preferred embodiment.

### DETAILED DESCRIPTION OF A PREFERRED EMBODIMENT

The present disclosure is directed toward preparation of polysiloxane urethane polymers that comprise terminal functional groups selected from (meth)acrylate, isocyanate, or mixtures thereof and use of these polymers in liquid optically clear adhesive (LOCA) compositions. The LOCA compositions preferably comprise: (A) the terminally functionalized polysiloxane urethane polymers according to the present disclosure; (B) optionally, (meth)acrylate monomers; (C) at least one photoinitiator; (D) optionally, an organometallic catalyst; and (E) optionally additional processing aids. The LOCA compositions prepared according to the present disclosure are curable by exposure to at least one of and preferably by both ultraviolet (UV)/visible light and moisture. The polysiloxane urethane polymers that are terminally functionalized with (meth)acrylate, isocyanate, or mixtures thereof according to the present disclosure incorporate multiple organic segments and multiple silicone segments in the same polymer backbone. They are formed by reacting a hydroxyl terminated organopolysiloxane with an excess of equivalents of organic polyisocyanate or diisocyanate to form an organic-silicone block co-polymer that has a clear appearance.

The block organic-silicone co-polymers have terminating ends that comprise isocyanate functional groups which can be further partially or fully reacted to provide the final co-polymer with terminal (meth)acrylate and/or isocyanate functional groups. These terminal (meth)acrylate and/or isocyanate functional groups provide photocuring and moisture curing, respectively, to the polymers. The formed polysiloxane urethane polymers that are terminally functionalized with (meth)acrylate, isocyanate, or mixtures thereof and LOCA compositions formed from them have surprisingly improved compatibility with photoinitiators and moisture cure catalysts compared to conventional LOCA adhesives. They also have lower moisture permeability than the silicone polymers and lower shrinkage compared to the organic acrylate polymers. These features make them ideal for many applications such as bonding of automotive displays and other structures, especially where both radiation curing and moisture curing are desirable.

### Component (A)

The compositions include the terminally functionalized polysiloxane urethane polymers. The terminally functionalized polysiloxane urethane polymers can be prepared by reacting a hydroxy terminated organopolysiloxanes and an organic polyisocyanate to form a polysiloxane urethane intermediate. The equivalents balance of OH to NCO moieties during the reaction should be chosen to provide the polysiloxane urethane intermediate with isocyanate functionality. Preferably an excess of isocyanate moieties is used to ensure that the polysiloxane urethane intermediate has only terminal isocyanate groups.

Some useful hydroxyl terminated organopolysiloxanes have the following structure:

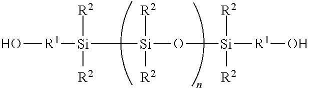

Each R¹ is independently chosen from C₁-C₁₂ alkyl, preferably C₁-C₆ alkyl, C₂-C₁₂ alkylether e.g. one or more 0 atoms between the C atoms, C₃-C₆ alicyclic and phenyl. Any R¹ can be independently substituted in any position by alkyl, alkoxy, halogen or epoxy moieties. Each R² is independently chosen from C1-C12 alkyl, preferably C1-C6 alkyl, C3-C6 alicyclic and phenyl. Any R² can be independently substituted in any position by alkyl, alkoxy, halogen or epoxy moieties. n can be an integer up to about 2,000, but n is more typically an integer from 1 to 200, preferably 5 to 200 and more preferably 10 to 150. Exemplary hydroxyl terminated organopolysiloxanes include the carbinol terminated polydimethylsiloxanes available from Gelest, Inc. and the linear polydimethylsiloxane propylhydroxy copolymers available from Siltech Corp and KF 6001, KF 6002 and KF 6003 available from Shin-Etsu Chemical. The Shin-Etsu Chemical materials are believed to have molecular weights from 1,000 to 10,000 and n values from 12 to 120.

The organic polyisocyanate is preferably an organic diisocyanate monomer. Some suitable organic diisocyanate monomers include aliphatic diisocyanates. Useful aliphatic diisocyanates include hexamethylene diisocyanate (HDI), methylene dicyclohexyl diisocyanate or hydrogenated MDI (HMDI) and isophorone diisocyanate (IPDI). Aromatic diisocyanates can develop haze and/or coloration and are not preferred for applications where optical clarity is desired.

The isocyanate functional polysiloxane urethane intermediate is reacted with compounds containing a group reactive with isocyanate moieties (e.g. hydroxy, amine, mercapto). Some useful compounds containing an isocyanate reactive group can have the formula:

HₘZ—R³—R⁴

where m is an integer from 1 to 2; Z is selected from O, N and S; R³ is selected from a covalent bond, alkyl, alkylether, ether, polyether, ester, polyester, carbonate, polycarbonate; and R⁴ is selected from (meth)acrylate and C₁-C₁₂ alkyl. Some useful methacrylate containing compounds are hydroxyl group containing mono(meth)acrylates and hydroxyl group containing polyether mono(meth)acrylates. Examples of some useful methacrylate containing compounds include hydroxyethyl (meth)acrylate; hydroxylpropyl (meth)acrylate; hydroxybutyl(meth)acrylate; phenoxy hydropropyl (meth)acrylate pentaerythritol tri(meth)acrylate; caprolactone modified (meth)acrylates such as 2-(caprolactone)ethyl (meth)acrylate; polypropylethyleneglycol mono(meth)acrylate, polyethylenglycol mono(meth)acrylate, polyester alcohol mono(meth)acrylates, and polycarbonate alcohol mono(meth)acrylates. Preferably, the polysiloxane urethane intermediate is reacted with polyether alcohol mono(meth)acrylates, such as polypropylethyleneglycol mono(meth)acrylate and/or polyethylenglycol mono(meth)acrylate. Any isocyanate functional group remaining in the prepolymer after reaction with the compound containing isocyanate reactive group can optionally be further reacted with a monofunctional alcohol such as methanol, ethanol, butanol, octanol, etc., to cap a portion or all of those remaining isocyanate terminal groups. In the present disclosure and claims the term (meth)acrylate is intended to mean, but is not limited to, corresponding derivatives of both acrylic acids and methacrylic acids. The resulting polysiloxane urethane polymer is an organic-silicone block copolymer with multiple urethane blocks, multiple organosiloxane blocks and terminal (meth)acrylate functionality and/or terminal isocyanate functionality.

If the isocyanate functional polysiloxane urethane intermediate is reacted with a compound containing a methacrylate moiety and a different compound containing a silyl alkoxy moiety, for example H₂NCH₂CH₂CH₂Si(OCH₃)₃, it is possible to obtain a polysiloxane urethane polymer that is an organic-silicone block copolymer with multiple urethane blocks, multiple organosiloxane blocks having terminal (meth)acrylate functionality, terminal silylalkoxy functionality and optionally terminal isocyanate functionality. The polysiloxane urethane polymer preferably contains no alkoxysilyl moieties.

Preferably the multiple silicone segments of the terminally functionalized polysiloxane urethane polymers prepared according to the present disclosure comprise from 50 to 98% by weight of the polymer, more preferably from 80 to 98% by weight based on the total polymer weight. Preferably the multiple organic urethane segments, comprise from 2 to 50% by weight of the polymer, and more preferably from 2 to 20% by weight based on the total polymer weight. Preferably the terminally functionalized polysiloxane urethane polymers designed according to the present disclosure have a number average molecular weight of from 1,000 to 100,000, more preferably from 3,000 to 70,000. Preferably the terminally functionalized polysiloxane urethane polymers according to the present disclosure are used in the LOCA composition in an amount of from 30 to 99.8% by weight, more preferably from 50 to 95% by weight based on the total weight of the LOCA composition.

### Component (B)

The compositions optionally include one or more (meth)acrylate containing monomers and/or (meth)acrylate containing oligomers or polymers. The optional (meth)acrylate monomers used in the present disclosure should not be reactive with the terminally functionalized polysiloxane urethane polymer. Other than this condition the optional (meth)acrylate monomers are not especially limited and can comprise one or more derivatives of acrylic acids and (meth)acrylic acids. The (meth)acrylate monomer may be a monofunctional (meth)acrylate monomer, i.e., one (meth)acrylate group is contained in the molecule, or it can be a multifunctional (meth)acrylate monomer, i.e., two or more (meth)acrylate groups are contained in the molecule. The suitable monofunctional (meth)acrylate monomers include, by way of example only and not limitation:isooctyl (meth)acrylate; tetrahydrofuranyl (meth)acrylate; cyclohexyl (meth)acrylate; dicyclopentanyl (meth)acrylate; dicyclopentanyloxy ethyl (meth)acrylate; N,N-diethylaminoethyl (meth)acrylate; 2-ethoxyethyl (meth)acrylate; caprolactone modified (meth)acrylate; isobornyl (meth)acrylate; lauryl (meth)acrylate; acryloylmorpholine; N-vinylcaprolactam; nonylphenoxypolyethylene glycol (meth)acrylate; nonylphenoxypolypropylene glycol (meth)acrylate; phenoxy ethyl (meth)acrylate; phenoxy di(ethylene glycol) (meth)acrylate; and tetrahydrofuranyl (meth)acrylate. The suitable multifunctional (meth)acrylate monomer can include, by way of example and not limitation: 1,4-butylene glycol di(meth)acrylate; dicyclopentanyl di(meth)acrylate; ethylene glycol di(meth)acrylate; dipentaerythritol hexa(meth)acrylate; caprolactone modified dipentaerythritol hexa(meth)acrylate; 1,6-hexanediol di(meth)acrylate; neopentyl glycol di(meth)acrylate; polyethylene glycol di(meth)acrylate; tetraethylene glycol di(meth)acrylate; trimethylolpropane tri(meth)acrylate; tris(acryloyloxyethyl) isocyanurate; caprolactone modified tris(acryloyloxyethyl) isocyanurate; tris(methylacryloyloxyethyl) isocyanurate and tricyclodecane dimethanol di(meth)acrylate. The monofunctional (meth)acrylate monomers and multifunctional (meth)acrylate monomers may be used individually or in a combination of two or more monomers, respectively, or the monofunctional (meth)acrylate monomer and multifunctional (meth)acrylate monomer can be combined together. Preferably, when present, the (meth)acrylate monomer is present in the LOCA composition in an amount of from 0 to 50% by weight, more preferably from 1 to 10% by weight based on the total weight of the LOCA composition.

### Component (C)

The compositions include one or more photoinitiators. The photoinitiator is used to initiate the radiation cure crosslinking of the terminal (meth)acrylate groups and (meth)acrylate monomer, if present. The suitable photoinitiators are any free radical initiator known in the art, and preferably is one or more selected from, for example: benzil ketals; hydroxyl ketones; amine ketones and acylphosphine oxides, such as 2-hydroxy-2-methyl-1-phenyl-1-acetone; diphenyl (2,4,6-triphenylbenzoyl)-phosphine oxide; 2-benzyl-dimethylamino-1-(4-morpholinophenyl)-butan-1-one; benzoin dimethyl ketal dimethoxy acetophenone; a-hydroxy benzyl phenyl ketone; 1-hydroxy-1-methyl ethyl phenyl ketone; oligo-2-hydoxy-2-methyl-1-(4-(1-methyvinyl)phenyl)acetone; benzophenone; methyl o-benzyl benzoate; methyl benzoylformate; 2-diethoxy acetophenone; 2,2-disec-butoxyacetophenone; p-phenyl benzophenone; 2-isopropyl thioxanthenone; 2-methylanthrone; 2-ethylanthrone, 2-chloroanthrone; 1,2-benzanthrone; benzoyl ether; benzoin ether; benzoin methyl ether; benzoin isopropyl ether; α-phenyl benzoin; thioxanthenone; diethyl thioxanthenone; 1,5-acetonaphthone; 1-hydroxycyclohexylphenyl ketone; ethyl p-dimethylaminobenzoate; Michler's ketone; dialkoxyacetophenones such as diethoxyacetophenone (DEAP). These photoinitiators may be used individually or in combination. In the LOCA compositions of the present invention, based on the total weight of the LOCA composition, the amount of the photoinitiator is preferably from about 0.02 to 3% by weight, more preferably from 0.3 to 1% by weight. The photoinitiator used in the present disclosure may be a commercially available one, including, for example, Irgacure 184 and Irgacure TPO-L from BASF Corporation.

### Component (D)

The compositions optionally include one or more moisture cure catalysts, preferably organometallic catalysts. The optionally included organometallic catalysts suitable for use according to the present disclosure are not particularly limited, and can comprise stannous octanoate, dibutyltin dilaurate, dibutyltin diacetate, bismuth based catalysts such as bismuth carboxylate and other known organometallic catalysts. These organometallic catalysts are clear to pale yellow liquids, and can be used to accelerate the moisture curing reaction. In the LOCA compositions of the present disclosure, based on the total weight of the composition, the amount of the organometallic catalyst present when in the formulation is preferably from 0.005 to 1% by weight, more preferably from 0.05 to 0.2% by weight.

### Component (E)

The compositions can optionally further comprise one or more additives selected from photostabilizers, fillers, thermal stabilizers, leveling agents, thickeners and plasticizers. A person skilled in the art would realize the detailed examples of each of these type of the additives and how to combine them to achieve desired properties in the composition. Preferably, the total amount of additives, based on the total weight of the LOCA composition, is from 0 to 5% by weight, more preferably 0 to 2% by weight, particularly preferred 0 to 1% by weight based on the total weight of the LOCA composition.

The LOCA compositions according to the present disclosure preferably have a haze value of from 0 to 2, more preferably from 0 to 1. The LOCA compositions according to the present disclosure preferably have a yellowness (b*) value of from 0 to 2, more preferably from 0 to 1.

### EXAMPLES

### Test Methods

The viscosity of each polymer was measured at 25° C. at 12 reciprocal seconds using a cone and plate rheometer. The results are reported in units of millipascal seconds (mPa·s).

“The ultraviolet (UV) curing was conducted using a metal halide lamp or a UV-LED array (405 nm) with UV irradiation energy of about 3000 mJ/cm² or more. Shore 00 hardness was measured according to ASTM D2240. Laminated samples were prepared by placing a layer of adhesive between two glass slides, the layer having a coating thickness of 300 microns (μ), and then curing the adhesive by UV light as described previously. After the samples were cured they were tested for transmittance and the yellowness b* value using a V-660 UV/vis spectrophotometer available from JASCO Corporation and haze value using HM-1:50 hazemeter available from Murakami Color Research Laboratory in compliance with ASTM D1003. Thereafter the samples were subjected to reliability testing conditions and the measurements were repeated. The laminated samples were then placed at high temperature, 90° C., high humidity/high temperature, 85° C./85% RH and QUV condition, 1 W/m², using QUV/se available from Q-Lab Corporation, for up to 1,000 hours to observe if any defects developed after aging.”

Moisture curing was conducted in a humidity chamber at 23±2° C., 50±10% relative humidity (RH). UV and moisture dual curing was performed by first curing the compositions with the mercury arc light and then the adhesives were placed in a humidity chamber and moisture cured for the indicated period of time. Shore 00 hardness was measured according to ASTM D2240.

The photo rheometer measurements were performed at 25° C. using an Anton Paar rheometer MCR302 using Light guide Omnicure 2000 with an intensity of 100 mw/cm².

Unless otherwise specified molecular weight is weight average molecular weight Mw. The weight average molecular weight M_{w}, is generally determined by gel permeation chromatography (GPC, also known as SEC) at 23° C. using a polystyrene standard. This method is known to one skilled in the art.

### Example 1

### Preparation of Light Curable PDMS Organic Urethane Polymer Capped with Polypropyleneglycol Monoacrylate (PPA-6)

To a jacketed reaction vessel equipped with an overhead stirrer, a nitrogen inlet/outlet and thermocouple was added a reactive silicone KF 6002 (OH #32 mg KOH/g) from ShinEtsu (660.0 g, 0.376 moles) and IPDI (51.7 g, 0.463 moles of NCO, NCO/OH 1.2) under N2. The mixture was heated to 70° C., then dibutyltin dilaurate (0.12g) was added into the mixture and allowed to stir for 2 hours. Then PPA-6 (16.0 g, 38.1 mmol) (Biscomer PPA6 from GEO specialty Chemicals) was added with dried air passing through the reaction mixture and allowed to react for 1 hour. FT-IR was used to monitor the reaction progress and about 50% decrease of the NCO band at 2340-2200 cm−1 was evidence that the PPA-6 capping is complete. Then n-BuOH (6.0 g, 215 mmol) was added to the reaction mixture and allowed to react for about 1 hr. The disappearance of the NCO band around 2340-2220 cm−1 with C—H band around 3200-2700 cm−1 as internal standard in FT-IR was evidence that the NCO and OH reaction was complete. The functionalized organo-silicone polyurethane polymer is flowable and clear liquid having a viscosity of about 175,000 cP, at 12 s−1 and 25° C. The organo-silicone polyurethane polymer contains about 50% acrylate moieties and about 50% O OBu moieties, e.g. all of the isocyanate moieties of the intermediate have been endcapped.

### Example 2

### Preparation of Light Curable PDMS Organic Urethane Polymer Capped with 4-hydroxybutyl Acrylate (4-HBA)

To a jacketed reaction vessel equipped with an overhead stirrer and thermocouple was added a reactive silicone fluid Silmer Di-50 (OH #28 mg KOH/g) from Siltech (50.0 g, 0.0998 moles) and 1,6-hexane diisocyanate (2.94 g, 0.0698 moles of NCO, NCO/OH 1.4) under N2. The mixture was heated to 70° C., then dibutyltin dilaurate (0.02 g) was added into the mixture and allowed to stir for 1 hours. Then 4-hydroxybutyl acrylate (2.78 g, 19.3 mmol) was added and allowed to mix for 1 hour. FT-IR was used to monitor the reaction progress and the disappearance of the NCO band around 2340-2220 cm−1 with C—H band around 3200-2700 cm−1 as internal standard was evidence that the reaction was complete with quantitative yields. The The organo-silicone polyurethane polymer is a flowable and clear liquid having a viscosity of about 10,000 cP, at 12 s−1 and 25° C. The functionalized organo-silicone polyurethane polymer contains 100% acrylate moieties, e.g. all of the isocyanate moieties of the intermediate have been endcapped.

### Example 3

### Preparation of Light Curable PDMS Organic Urethane Polymer Capped with 4-hydroxybutyl Acrylate (4-HBA)

To a jacketed reaction vessel equipped with an overhead stirrer and thermocouple was added a reactive silicone fluid Silmer Di-10 (OH #120 mg KOH/g) from Siltech (50.22 g, 0.107 moles) and 1,6-hexane diisocyanate (9.52 g, 0.112 moles of NCO, NCO/OH 1.05) under N2. The mixture was heated to 70° C., then dibutyltin dilaurate (0.02 g) was added into the mixture and allowed to stir for 1 hours. Then 4-hydroxybutyl acrylate (2.49 g, 17.34 mmol) was added and allowed to mix for 1 hour. FT-IR was used to monitor the reaction progress and the disappearance of the NCO band around 2340-2220 cm−1 with C—H band around 3200-2700 cm−1 as internal standard was evidence that the reaction was complete with quantitative yields. The The functionalized organo-silicone polyurethane polymer is a flowable and clear liquid having a viscosity of about 57,000 cP, at 12 s—1 and 25° C. The functionalized organo-silicone polyurethane polymer contains 100% acrylate moieties, e.g. all of the isocyanate moieties of the intermediate have been endcapped with acrylate moieties.

### Example 4

### Preparation of a 100% Acrylated Polyurethane Capped with Hydroxyethyl Acrylate (HEA)

To a jacketed reaction vessel equipped with an overhead stirrer and thermocouple was added 1,6-hexane diisocyanate (6.58 g, 0.078 moles of NCO) and dibutyltin dilaurate (0.015 g) and the mixture was heated to 70° C. under N2, a reactive silicone fluid Pro-1384 (OH #67.2 mg KOH/g) from Nusil (50 g, 0.12 moles) was added dropwisely into the mixture and allowed to stir for 1 hours. Then 2-hydroxyethyl acrylate (2.1 g, 18.0 mmol) was added into the reaction mixture, the viscosity of the mixture was very high and the reaction was stopped. When it was cooled to room temperature, the reaction mixture became waxy and not flowable.

The light curable formulations and test results are summarized in the Tables below.

Samples 1-1, 2-1 and 3-1 are compositions prepared using polysiloxane urethane polymer examples 1, 2 and 3 respectively.

### Light Curable Formulations and its Properties after Light Cured

Compositions were prepared as shown in the following Table and radiation cured as previously described.

| | Example | | |
|---|---|---|---|
| | 1-1 | 2-1 | 3-1 |
| Component | Wt % | Wt % | Wt % |
| Polymer 1 | 95.7 | 0 | 0 |
| Polymer 2 | 0 | 98.75 | 0 |
| Polymer 3 | 0 | 0 | 98.6 |
| monomer¹ | 4 | 1 | 1 |
| Irgacure TPO | 0.3 | 0.2 | 0.2 |
| Irgacure 819 | 0 | 0.05 | 0.05 |
| Tinuvin 292 | 0.2 | 0 | 0 |
| total | 100 | 100 | 100 |

¹Hydroxypropyl acrylate

All of Samples 1-1, 2-1 and 3-1 have good compatibility with Irgacure TPO and HPA.
Cured reaction products of light curable formulations 1-1, 2-1 and 3-1 were tested for their Shore 00 hardness and storage modulus G′ using a Photo-rheometer.

| | Example | | |
|---|---|---|---|
| | 1-1 | 2-1 | 3-1 |
| Hardness, Shore 00 | 8 | 50 | 30 |
| G′ Pa | 20,000 | 321,000 | 58,000 |

Formulations 1-1 and 3-1 had Shore 00 hardness values suitable for LOCA applications. Formulation 2-1 had much higher G′ and less desirable Shore 00 hardness value.

The optical properties (transmittance, yellowness and haze) of cured reaction products of formulation 1-1 were tested after initial cure, 240 hours and 560 hours of aging under high temperature (90 C), high humidity/high temperature, (85° C./85% RH) and QUV condition. The cured reaction products had surprisingly desirable high transmittance, low haze and yellowness b* values even after 560 hours of testing.

| test time | test type | Transmittance % | b * | Haze % |
|---|---|---|---|---|
| initial | | >99 | 0.10 | 0.1 |
| 240 hrs | 90 C. | >99 | 0.47 | 0.2 |
| 240 hrs | 85/85 | >99 | 0.80 | 0.2 |
| 240 hrs | QUV | >99 | 0.56 | 0.4 |
| 560 hrs | 90 C. | >99 | 0.40 | 1.1 |
| 560 hrs | 85/85 | >99 | 0.92 | 0.4 |
| 560 hrs | QUV | >99 | 0.19 | 0.1 |

### Example 5

### Preparation of Light and Moisture Curable PDMS Organic Urethane Polymer Capped with 50% PPA-6 Capped

To a reaction vessel equipped with an overhead stirrer and thermocouple was added reactive silicone KF 6001 (OH #59.6 mg KOH/g) from ShinEtsu (140.0 g, 0.149 moles), Irganox 1010 (0.010 g), and IPDI (30.17 g, 0.54 moles of NCO, NCO/OH 1.8) under N2. To the mixture in the reactor is then added dibutyltin dilaurate catalyst (0.030 g), The mixture was allowed to stir for 2 hours at 70° C. FT-IR was used to monitor the reaction progress.

Then Biscomer PPA-6 (25.0 g, 59.5 mmol) was added with dried air passing through the reaction mixture and allowed to react for 1 hour. FT-IR was used to monitor the reaction progress and about 50% decrease of the NCO band around 2340-2220 cm−1 with C—H band around 3200-2700 cm−1 as internal standard was evidence that the PPA-6 capping is complete.

The resin formed is flowable and clear liquid with viscosity 2,400 cP, at 12 s−1 and 25 C, the functionalized organo-silicone polyurethane polymer contains about 50% acrylate moieties and 50% NCO moieties, e.g. 50% of the isocyanate moieties of the intermediate have been endcapped with acrylate moieties and 50% of the isocyanate moieties remain.

### Example 6

### Preparation of Light and Moisture Curable PDMS Organic Urethane Polymer Capped with 50% PPA-6 Capped

To a reaction vessel equipped with an overhead stirrer and thermocouple was added reactive silicone KF 6001 (OH #59.6 mg KOH/g) from ShinEtsu (168.00 g, 0.178 moles), Irganox 1010 (0.012 g), and HDI (24.25, 0.57 moles of NCO, NCO/OH 1.6) under N2. To the mixture in the reactor is then added dibutyltin dilaurate catalyst (0.030 g), The mixture was allowed to stir for 2 hours at 70 C under N2. FT-IR was used to monitor the reaction progress.

Then Biscomer PPA-6 (22.48 g, 53.5 mmol) was added with dried air passing through the reaction mixture and allowed to react for 1 hour. FT-IR was used to monitor the reaction progress and about 50% decrease of the NCO band around 2340-2220 cm−1 with C—H band around 3200-2700 cm−1 as internal standard was evidence that the PPA-6 capping is complete.

The resin formed is flowable and clear liquid, the functionalized organo-silicone polyurethane polymer contains about 50% acrylate moieties and 50% NCO moieties, e.g. 50% of the isocyanate moieties of the intermediate have been endcapped with acrylate moieties and 50% of the isocyanate moieties remain.

### Example 7

### Preparation of Light and Moisture Curable PDMS Organic Urethane Polymer Capped with 30% PPA-6 Capped

To a reaction vessel equipped with an overhead stirrer and thermocouple was added reactive silicone KF 6001 (OH #59.6 mg KOH/g) from ShinEtsu (168.00 g, 0.178 moles), Irganox 1010 (0.012 g), and HDI (19.74, 0.47 moles of NCO, NCO/OH 1.3) under N2. To the mixture in the reactor is then added dibutyltin dilaurate catalyst (0.036 g), The mixture was allowed to stir for 2 hours at 70° C. under N2. FT-IR was used to monitor the reaction progress.

Then Biscomer PPA-6 (6.74 g, 16.0 mmol) was added with dried air passing through the reaction mixture and allowed to react for 1 hour. FT-IR was used to monitor the reaction progress and about 30% decrease of the NCO was observed, then n-Octanol (2.8 g, 21.3 mmol) was added and allowed to react for another hour. FT-IR was used to monitor the reaction progress and about 40% further decrease of the NCO was observed.

The functionalized organo-silicone polyurethane polymer formed is flowable liquid. The functionalized organo-silicone polyurethane polymer contains about 30% acrylate moieties, 30% NCO moieties and about 40% 0 Octyl moieties.

### Example 8

### Preparation of Light and Moisture Curable PDMS Organic Urethane Polymer Capped with 30% PPA-6 Capped

To a jacketed reaction vessel equipped with an overhead stirrer and thermocouple was added reactive silicone KF 6002 (OH #35.2 mg KOH/g) from ShinEtsu (252.0 g, 0.158 moles) and BHT (0.027 g). To the mixture in the reactor is added slowly HDI (16.7 g, 0.199 moles of NCO, NCO/OH 1.25) under N2, then added K-KAT 640 Bi catalyst from King Industries (0.072 g), The mixture was allowed to stir for 2 hours at 70° C. under N2. Then PPA-6 (5.0 g, 11.9 mmol) was added with dried air passing through the reaction mixture and allowed to react for 1 hour. FT-IR was used to monitor the reaction progress and about 30% decrease of the NCO band around 2340-2220 cm−1 with C—H band around 3200-2700 cm−1 as internal standard was evidence that the PPA-6 capping is complete. Then stabilizer 3-isocyanatopropyltrimethoxysilane (2.26 g, 11 mmol) was added to the reaction mixture and mixed for about 30 min before the batch was dischared into a epoxy coated can under N2 protection. The resin formed is a flowable and a clear liquid having a viscosity of about 22,000 cP, at 12 s−1 and 25° C. The functionalized organo-silicone polyurethane polymer contains about 30% acrylate moieties and 70% NCO moieties.

### Example 9

### Preparation of Light and Moisture Curable PDMS Organic Urethane Polymer Capped with 40% PPA-6 Capped

To a jacketed reaction vessel equipped with an overhead stirrer and thermocouple was added reactive silicone KF 6002 (OH #35.2 mg KOH/g) from ShinEtsu (252.0 g, 0.158 moles), Irganox 1010 (0.014 g) and BHT (0.014 g). To the mixture in the reactor is added slowly HDI (17.46 g, 0.207 moles of NCO, NCO/OH 1.30) under N2, then added K-KAT 640 Bi catalyst from King Industries (0.069 g), The mixture was allowed to stir for 2 hours at 70° C. under N2. Then PPA-6 (8.75 g, 18.9 mmol) was added with dried air passing through the reaction mixture and allowed to react for 1 hour. FT-IR was used to monitor the reaction progress and about 40% decrease of the NCO band around 2340-2220 cm−1 with C—H band around 3200-2700 cm−1 as internal standard was evidence that the PPA-6 capping is complete. Then stabilizer 3-isocyanatopropyltrimethoxysilane (2.25 g, 11 mmol) was added to the reaction mixture and mixed for about 30 min before the batch was dischared into a epoxy coated can under N2 protection. The resin formed is flowable and a clear liquid with viscosity 22,000 cP, at 12 s−1 and 25 C, the functionalized organo-silicone polyurethane polymer contains about 40% acrylate moieties and 60% NCO moieties.

| | Example # | | | | |
|---|---|---|---|---|---|
| | 5 | 6 | 7 | 8 | 9 |
| NCO Raws | IPDI | HDI | HDI | HDI | HDI |
| Ratio | 1.8 | 1.6 | 1.3 | 1.25 | 1.3 |
| NCO/OH | | | | | |
| Capper Ratio | 50/50/0 | 50/50/0 | 30/30/40 | 30/70/0 | 40/60/0 |
| Acry/NCO/OR | | | | | |
| Resin initial | 2,400 | ND | ND | 22,000 | 16,000 |
| viscosity | | | | | |
| cP | | | | | |

Samples 5-1, 6-1, 7-1, 8-1 and 9-1 are compositions prepared using polysiloxane urethane polymer examples 5,6,7,8 and 9 respectively. The light and NCO moisture dual curable formulations and test results are summarized in the Tables below.

| | Formulations # | | | | |
|---|---|---|---|---|---|
| | 5-1 | 6-1 | 7-1 | 8-1 | 9-1 |
| Component | wt % | wt % | wt % | wt % | wt % |
| Polymer 5 | 95.7 | | | | |
| Polymer 6 | | 95.7 | | | |
| Polymer 7 | | | 95.7 | | |
| Example 8 | | | | 95.7 | |
| Example 9 | | | | | 95.7 |
| Ethylene glycol | 4 | 4 | 4 | 4 | 5 |
| methyl ether acrylate | | | | | |
| EGMEA, % | | | | | |
| TPO, % | 0.3 | 0.3 | 0.3 | 0.3 | 0.3 |
| Tin catalyst UL-28, ppm | 500 | 500 | 500 | 500 | 500 |
| Total | 100 | 100 | 100 | 100 | 100 |

The dual curable formulations were tested for their storage modulus G′ with Photo-rheometer during UV curing , then open the chamber for continuous moisture curing at about 50% humidity RT for two to three days.

| | Formulations # | | | | |
|---|---|---|---|---|---|
| | 5-1 | 6-1 | 7-1 | 8-1 | 9-1 |
| G′, Pa, | 9,370 | 13,000 | 3,500 | 1,200 | 5,000 |
| UV cured only | | | | | |
| G′, Pa | 50,000 | >1,000,000 | 125,000 | 130,000 | 170,000 |
| UV plus Moisture cure | 2 days | 2 days | 3 days | 3 days | 3 days |

Formulations 5-1 and 6-1 had too low or high G′ and are not suitable for LOCA applications. Formulations 7-1, 8-1 and 9-1 had good range of G′ and are suitable for LOCA applications

The foregoing disclosure has been described in accordance with the relevant legal standards, thus the description is exemplary rather than limiting in nature. Variations and modifications to the disclosed embodiment may become apparent to those skilled in the art and do come within the scope of the disclosure. Accordingly, the scope of legal protection afforded this disclosure can only be determined by studying the following claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an amount, concentration, or other value or parameter is given as either a range, a preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

We claim:

1. A terminally functionalized polysiloxane urethane polymer comprising:
multiple organopolysiloxane segments, the organopolysiloxane segments comprising from 50 to 98% by weight based on the total polymer weight;
multiple urethane segments, the urethane segments comprising from 2 to 50% by weight based on the total polymer weight; and
terminal functional groups selected from at least one of (meth)acrylate functional groups, isocyanate functional groups, or combinations thereof.

2. A terminally functionalized polysiloxane urethane polymer as recited in claim 1, comprising a terminal (meth)acrylate functional group.

3. A terminally functionalized polysiloxane urethane polymer as recited in claim 1, comprising a terminal isocyanate functional group.

4. A terminally functionalized polysiloxane urethane polymer as recited in claim 1, comprising a mixture of terminal (meth)acrylate functional groups and terminal isocyanate functional groups.

5. A terminally functionalized polysiloxane urethane polymer as recited in claim 1, comprising a mixture of terminal (meth)acrylate functional groups and terminal silylalkoxy groups and optionally terminal isocyanate functional groups.

6. A terminally functionalized polysiloxane urethane polymer as recited in claim 1, wherein said polymer has a number average molecular weight of from 1,000 to 100,000, preferably from 3,000 to 70,000.

7. A liquid optically clear adhesive composition comprising:
30 to 99.8% by weight based on the total composition weight of the terminally functionalized polysiloxane urethane polymer as recited in claims 1;
0 to 50% by weight based on the total composition weight of at least one (meth)acrylate monomer;
optionally a photoinitiator;
optionally a moisture curing catalyst; and
0 to 5% by weight based on the total composition weight of one or more additives selected from photostabilizer, filler, thermal stabilizer, leveling agent, thickener and plasticizer.

8. A liquid optically clear adhesive composition as recited in claim 7 wherein said terminally functionalized polysiloxane urethane polymer comprises both terminal (meth)acrylate functional groups and terminal isocyanate functional groups.

9. A liquid optically clear adhesive composition as recited in claim 7, being UV curable and moisture curable.

10. A liquid optically clear adhesive composition as recited in claim 7, comprising 1 to 4% by weight based on the total composition weight of the at least one (meth)acrylate monomer and/or (meth)acrylate oligomer/polymer.

11. A liquid optically clear adhesive composition as recited in claim 7, comprising 0.005 to 1% by weight based on the total weight of the composition of the catalyst, wherein the catalyst is a moisture curing catalyst.

12. Cured reaction products of the liquid optically clear adhesive composition as recited in claim 7 having a haze value of from 0 to 2%.

13. Cured reaction products of the liquid optically clear adhesive composition as recited in claim 7 having a haze value of from 0 to 2% after being stored for 500 hours at 85° C. and 85% relative humidity.

14. Cured reaction products of the liquid optically clear adhesive composition as recited in claim 7 having a yellowness b* value of from 0 to 2.

15. Cured reaction products of the liquid optically clear adhesive composition as recited in claim 7 having a yellowness b* value of from 0 to 2 after being stored for 500 hours at 85° C. and 85% relative humidity.

16. A method of making a curable polysiloxane urethane polymer comprising:
providing a hydroxy terminated organopolysiloxane;
providing an aliphatic diisocyanate;
reacting an excess of equivalents of the aliphatic diisocyanate with the hydroxy terminated organopolysiloxane to form an isocyanate functional polysiloxane urethane intermediate; and
reacting the isocyanate functional polysiloxane urethane intermediate with an isocyanate reactive compound containing (meth)acrylate groups to provide the curable polysiloxane urethane polymer.

17. The method of claim 16 wherein the isocyanate reactive compound has the formula:
HₘZ—R³—R⁴
where m is an integer from 1 to 2; Z is selected from O, N and S; R³ is selected from a covalent bond, alkyl, alkylether, ether, polyether, ester, polyester, carbonate, polycarbonate; and R⁴ is (meth)acrylate.
